(19) United States
(12) Patent Application Publication
(10) Pub. No.: US 2010/0161355 A1
(43) Pub. Date: Jun. 24, 2010

(54) SINGLE FIELD ENTRY ELECTRONIC CLINICAL CHART NOTE ENTRY SYSTEM

(76) Inventor: Peter STANGEL, Palisades, NY (US)

Correspondence Address: GREENBERG TRAURIG, LLP (DC/ORL), 2101 L Street, N.W., Suite 1000, Washington, DC, 20037, US

(21) Appl. No.: 12/623,128

(22) Filed: Nov. 20, 2009

Related U.S. Application Data
(60) Provisional application No. 61/121,211, filed on Dec. 10, 2008.
(60) Provisional application No. 61/116,383, filed on Nov. 20, 2008.

(51) Int. Cl. G06Q 10/00; G06Q 50/00; G06F 3/048; G06F 3/01

(52) U.S. Cl. 705/3; 715/780; 715/760; 715/853; 715/764

(57) ABSTRACT

A system and methods including a web browser (client side) single computer screen interface or mobile device single screen interface which enables the user to electronically record the clinical findings of a patient-clinician clinical encounter to create an electronic clinical chart note by entering the findings into a Single Text Field which then displays these findings in clinical chart note format, a format which emulates the format of the paper clinical chart note, without repeated submissions and communication to the server during chart note creation. The completed clinical chart note is then sent to the server for storage and retrieval. Cumulative stored electronic clinical chart notes for each individual patient constitute that patient's EMR.

This application claims priority to U.S. Provisional Application Ser. No. 61/121,211 filed on Dec. 10, 2008 and U.S. Provisional Application Ser. No. 61/116,383 filed on Nov. 20, 2008, the entire disclosures of which are incorporated herein by reference. In addition, this application incorporates herein by reference in their entirety the disclosures and teachings of the following related U.S. patent applications: U.S. patent application Ser. No. 09/772,394 filed on Jan. 30, 2001; U.S. Provisional Patent Application Ser. No. 60/247,246, filed on Nov. 13, 2000, entitled “UMsource Software”; U.S. patent application Ser. No. 11/530,374 filed on Sep. 8, 2006; and Provisional U.S. Patent Application Ser. No. 60/714,968, filed Sep. 8, 2005.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of electronic medical record interfaces, and in particular to a web browser interface which enables the user to create an entire electronic clinical chart note entirely from a single text field and display the clinical char in clinical chart note format.

### BACKGROUND OF THE INVENTION

Healthcare in the United States is widely considered to be mediocre in quality, high in cost, with over-utilization of resources and over-reliance on high technology. How to fix healthcare has become a national issue. The electronic medical record (EMR) is being advocated as a major part of the fix. Because EMRs are currently used by only a minority of physicians, other healthcare providers and hospitals, there is a national initiative to encourage the adoption of EMRs. Physicians and other healthcare providers have been reluctant to embrace EMRs for reasons that include the complexity of the EMR computer screen interfaces, steep learning curves, varying proprietary formats and limited accessibility (local networks). EMRs may require navigation of multiple screens for the creation of a single EMR note, require extensive scrolling and clicking, require laborious manual keyboard input. Such EMRs are time consuming to create and may be in non-clinical format.

### SUMMARY OF THE INVENTION

Migration to the EMR from the paper chart would be facilitated by offering a single text field in a simple single screen interface which concurrently displays the entered data in clinical chart note format and is accessible via the Internet through a web browser on a computer or mobile device. The presently disclosed system and method includes a novel web browser interface which enables the user to create an entire electronic clinical chart note from a Single Text Field, in clinical chart note format and displays the clinical chart note concurrently, as the clinical data is being entered. A clinical chart note is a record created by the clinician of the clinical findings regarding a single patient-clinician clinical encounter. The electronic clinical chart note format resembles the format of the paper clinical chart note format. In addition to clinicians, other users may create the clinical chart note.

In the doctor's office, the doctor can create an electronic clinical note on a computer in the examination room during or immediately after an examination. The clinical note may be made on a computer in the doctor's consultation room, where the patient and physician may meet after an exam. Alternatively, in the hospital, the physician can create the clinical chart note on a mobile device in the patient's hospital room as he is making rounds on each patient, or on a computer in the physician area at the nursing station. Alternatively, a nurse or some other employee in the hospital/doctor's office can extract the clinical information from a paper chart and create an electronic clinical chart note.

The present system and method includes a web browser (client side) single computer screen interface or mobile device single screen interface which enables the user to electronically record the clinical findings of a patient-clinician clinical encounter to create an electronic clinical chart note by entering the findings into a Single Text Field which then displays these findings in clinical chart note format, a format which emulates the format of the paper clinical chart note, without repeated submissions and communication to the server during chart note creation. The completed clinical chart note is then sent to the server for storage and retrieval. Cumulative stored electronic clinical chart notes for each individual patient constitute that patient's EMR, which is available for retrieval.

The web browser or mobile device is connected to a server over the Internet or local area network (LAN), which stores system default reference clinical data and user-customized default clinical data which is transmitted over the Internet or LAN to enable the web browser or mobile device screen specifically to programmatically generate background interactive hierarchal lists that are used by the web browser/mobile device to facilitate the creation of an electronic clinical chart note by a user of a single patient-clinician clinical encounter in clinical chart note format (emulating the paper clinical chart note format), by user input into a Single Text Field. The completed clinical chart note is sent to the server for storage and subsequent retrieval. In certain embodiments, the web browser can be used solely on an unconnected single computer which also duplicates the functions of a server. Alternatively, the mobile device may duplicate a function of the server and act as a stand-alone device.

The user input into the Single Text Field is typically by keystroke. In certain embodiments, the Single Text Field enables programmatic text input from other input sources such as speech recognition of voice input, text downloads of data such as laboratory values and diagnostic test reports, text readings of biometric devices, from both proximate and remote devices. The Single Text Field acts as an intake point of this data which is then programmatically processed and organized for display in clinical chart note format in the clinical chart note.

In certain embodiments, the Single Text Field programmatically accepts text input of machine (computer/mobile device) assisted analysis of electronic sound inputs via audio file formats (e.g. “.wav”, “.mp3”) or by machine (computer/mobile device) assisted analysis of other biometric device inputs. In one embodiment, sound input via audio file formats is by electronic stethoscope. The devices may be either proximate or remote. In one embodiment, sound input is by a stethoscope-like diaphragm/bell or other audio device with direct sound input into the machine (computer/mobile device). In effect the machine/mobile device becomes a biometric device. The sound input is then programmatically analyzed by the machine/mobile device for entry in the Single Text Field.

The entire electronic clinical chart note is created on the web browser screen or mobile device screen, without repeated submissions and communication to the server during chart note creation. When the electronic clinical chart note has been completed, only then is the chart note submitted to the server over the Internet (or LAN) from the web browser/mobile device for storage and subsequent retrieval by the web browser/mobile device. Alternatively a mobile device may store multiple clinical chart notes and submit these notes in batch to the server over the Internet (or LAN). The server may subsequently transmit back the clinical data back to the web browser or the mobile device for display in clinical chart format, or for printing in clinical chart note format. In certain embodiments, the system and methods may also be used on a single unconnected computer or mobile device. The mobile device may include the iPhone, Blackberry, other smartphones, laptop computer, tablet, or personal digital assistant (PDA).

In certain embodiments, the Single Field Entry Electronic Clinical Chart Note System, can be used in healthcare, including patient-clinician clinical encounters, and other fields of endeavor which may require formatted electronic notes.

In one embodiment, a method for managing electronic medical records may comprise the steps of: receiving a clinical finding of a patient-clinician clinical encounter; creating an electronic clinical chart note; displaying the clinical finding in clinical chart note format, so that the clinical chart note format emulates a paper clinical chart note format; and storing the electronic clinical chart note to a server. The steps may be performed on a particular machine. The particular machine may comprise of a physical computing device. The steps may be performed on the same or separate machines. The clinical finding may be received via a single field.

In such an embodiment, the method may also comprise the step of transmitting the electronic clinical chart note to the server, where the server is remote. In addition, the method may comprise the step of retrieving the electronic clinical chart note from the server. Further, the method may comprise the steps of cumulating electronic clinical chart notes for a single patient and creating an electronic medical record for the single patient based on the electronic clinical chart notes for the single patient.

Moreover, in the method of such an embodiment, the electronic clinical chart note may be stored in clinical chart note format. Also, the clinical finding of the patient-clinician clinical encounter may be received via an user interface. The user interface may be a web browser. The clinical finding of the patient-clinician clinical encounter may be entered by a user via an user interface into a single field. The single field may be configured to receive the clinical finding from a source. The source may be a keyboard, a touch screen, a sound source, a data download, a biometric device, or an auscultatory device. The source of the input may be remote from the user interface. The web browser may be displayed by a screen on a device. The device may be a computer or a mobile device.

In certain embodiments, the method may also comprise of the step of programmatically generating interactive hierarchal lists for the creation of the electronic clinical chart note. The interactive hierarchal lists may comprise of four interactive hierarchal lists: Elements, System/Groups, Parameters and Findings for the creation of the electronic clinical chart note. These four interactive hierarchal lists may be the underpinning of the clinical chart note format. The method may also comprise of displaying the programmatically generated interactive hierarchal lists via the user interface.

In some embodiments, the hierarchal lists may be based on default clinical data, user modified terms, and/or the clinical findings of the previous patient-clinician clinical chart notes. The method may also comprise of displaying the programmatically generated interactive hierarchal lists via the user interface. In some embodiments, the method may further comprise of modifying the interactive hierarchal list. The modified hierarchal list may be based on a separate clinical finding. The separate clinical finding may be a subsequently received finding or a previously stored finding. The modified hierarchal list may be displayed via the user interface.

The programmatically generated interactive hierarchal list may contain items that are elements, systems, parameters, or findings. The method may also comprise of the step of selecting an item from the programmatically generated at least one interactive hierarchal list. Upon selecting an item, the method may programmatically generate a second interactive hierarchal list based on the selection. Each item listed in the programmatically generated interactive hierarchal list has a hierarchal child list. The second interactive hierarchal list is generated and displayed via the user interface. The displayed second list is the hierarchal child list corresponding to the selected item from the programmatically generated interactive hierarchal list.

Furthermore, the method may comprise of the step of prompting for clinical finding information. The prompts may be displayed based on findings already entered in the clinical chart note, the first letters of a received clinical finding, or a reason for the patient-clinician clinical encounter. In addition, the method may comprise of the step of concurrently displaying the clinical finding in clinical chart note format as the clinical finding is received. The clinical finding may displayed by tabbing past the single field.

In certain embodiments, the steps of the method may be performed on a single machine, separate machines, or any variation or combination of machines. The electronic clinical chart note may be based on a plurality of clinical findings. The clinical findings may be received via the single field. The method may also concatenate the clinical findings, and display the concatenated clinical findings. The clinical finding may be received via various techniques, such as cutting and pasting data, downloading text data, transmitting device readings, or providing a machine assisted analysis. The clinical finding may have a severity modifier or other modifier.

In another embodiment, an electronic medical records system may comprise of an interface that receives a clinical finding of a patient-clinician clinical encounter, a server that stores an electronic clinical chart note, and a particular machine that stores code for the interface and code for the server. The interface may display the clinical finding in clinical chart note format, so that the clinical chart note format emulates a paper clinical chart note format. The electronic clinical chart note may be based on clinical findings. The clinical findings may be received via a single field.

In an embodiment of the system, the code for the interface and the code for the server may be stored on a single or a separate machine. The interface may be a web browser. The web browser may be displayed by a screen on a device. The device may be a computer or a mobile device. The mobile device may include the iPhone, Blackberry, other smartphones, laptop computer, tablet, or personal digital assistant (PDA). The interface may be configured to receive the clinical finding from a source. The source may be a keyboard, a touch screen, a sound source, a data download, a biometric device, or an auscultatory device. The interface may programmatically generate interactive hierarchal lists based on the server-transmitted system default reference clinical data and user-customized default clinical data for the creation of the electronic clinical chart note. The interface may display the programmatically generated interactive hierarchal lists. Furthermore, the interface may retrieve the electronic clinical chart note from the server.

In yet another embodiment, a computer readable medium for managing electronic medical records may comprise of data that, when accessed by a machine, causes the machine to perform operations. The operations may comprise of the steps of receiving a clinical finding of a patient-clinician clinical encounter; creating an electronic clinical chart note; displaying the clinical finding in clinical chart note format so that the clinical chart note format emulates a paper clinical chart note format; and storing the electronic clinical chart note to a server. The operations may be executed on a particular machine. The particular machine may comprise of a physical computing device. The clinical finding may be received via a single field. The operations may be performed on the same or separate machines.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1-22 show screen captures of a web browser (client side) computer or mobile device single screen interface in accordance with certain embodiments of the invention.

FIG. 23 is a block diagram of a computer-based system for implementing a user interface for accessing various forms of clinical findings via the Internet in accordance with the invention.

FIG. 24 illustrates the logical arrangement of modules in a system in accordance with the invention.

### DETAILED DESCRIPTION OF THE PREFERRED EMBODIMENTS

Reference will now be made in detail to the preferred embodiments of the present invention, examples of which are illustrated in the accompanying drawings.

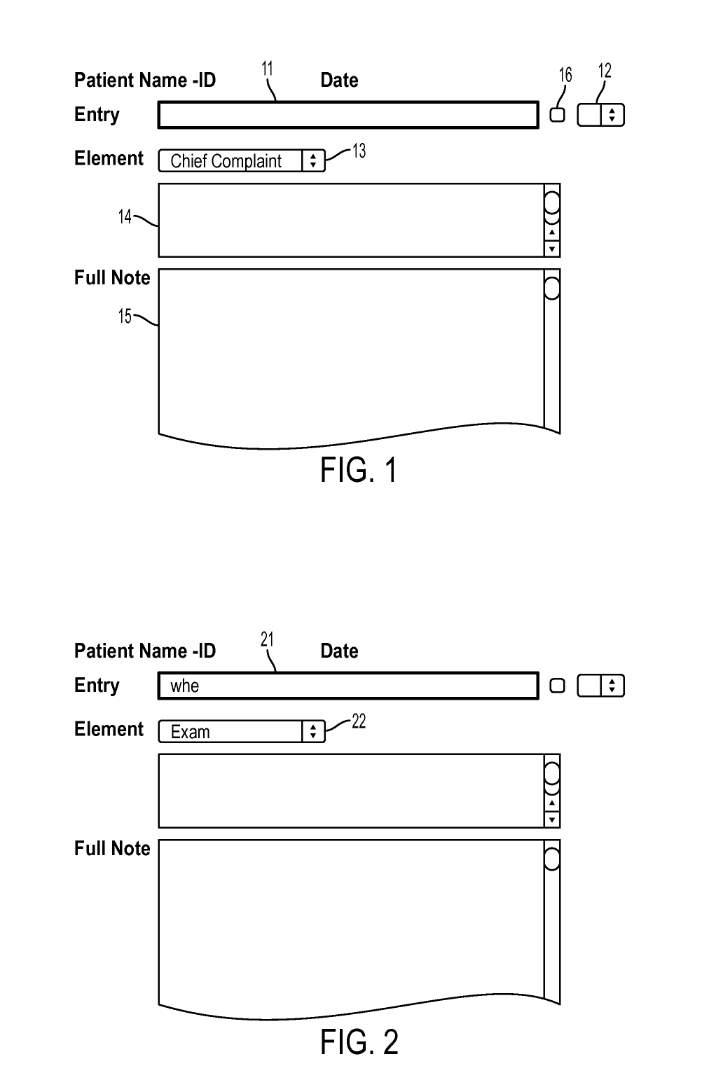

As illustrated in FIG. 1, the disclosed system and method includes a web browser (client side) single computer screen interface or mobile device single screen interface. The Clinical Chart Note Web Browser/Mobile Device Screen enables the user to create an entire electronic clinical chart note in clinical chart note format, emulating paper chart note format, by inputting characters into a single text field the Chart Note Entry Field 11. The inputted clinical data is concurrently displayed in clinical chart note format in the Current Element Area 14 and the Full Note Area 15 by tabbing past the Chart Note Entry Field. The entire Electronic Clinical Chart Note (ECCN) is created on the web browser or mobile device screen without repeated submissions and communication to the server during clinical chart note creation. The web browser/mobile device screen also contains two Pop-Up Button Lists: the View Items Pop-Up Button List 12 and the Chart Element Pop-Up Button List 13. The functions of the View Items Pop-Up Button List 12 include the display of programmatic background search results of hierarchal lists of text input into the Chart Note Entry Field 11 when background searches yield more than one result, the display of prompts that direct the user for entry of clinical findings describing specific Parameters, and the display of entered clinical Findings for review. The Chart Element Pop-Up Button List 13 contains the names of clinical chart note sections (Elements), displays the current clinical chart note Element, and allows selection of the current clinical chart note Element. The Findings Review Checkbox 16 signals the status of displayed Findings in the View Items Pop-Up Button List 12. A checked Findings Review Checkbox 16 signals that the displayed Finding is entered in the clinical chart note and allows modification or deletion of the selected Finding.

The Chart Note Entry Field 11 allows user input of one or more characters. Tabbing past this Field 11 causes a background programmatic web browser/mobile device search of the interactive hierarchal lists for matches to the inputted characters. The search result determines the subsequent actions by the web browser/mobile device. A single matching search result programmatically enters a clinically formatted entry in the Current Element Area 14 and the Full Note Area 15. Multiple search results programmatically populates the adjacent View Items Pop-Up Button List 12 with the search-related results. Alternatively, a single search result which requires a numerical value programmatically refreshes the Chart Note Entry Field 11 with the search result and an equal sign (=). If the search yields no matches and the amount of characters entered in the Chart Note Entry Field 11 exceeds a programmatically set amount of characters (e.g. 9), the text is programmatically entered in the Current Element Area 14 and the Full Note Area 15. Alternatively, user input of a single character into the Chart Note Entry Field 11 may perform other screen and programmatic actions.

The ECCN is organized in clinical chart note format, a format which emulates the paper chart clinical chart note format, the format taught in professional schools and used by clinicians to record the patient-clinician clinical encounter. The ECCN note is organized by chart sections which reflect the organization of the paper clinical chart and are called Elements. Elements may include: Chief Complaint, Present Illness, Past History, Examination, Lab Results, Diagnostic Study Results, Impression, and Assessment and Plan. These Elements are listed in the Chart Element Pop-Up Button List 13. Selection of an Element in the Chart Element Pop-Up Button List 13 sets the Current Element Area 14 to display the Finding line programmatically entered by user text entry in the Chart Note Entry Field 11 and displays the programmatically entered finding line under the selected Element's Header line in the Full Note Area 15. Tabbing past the Chart Note Entry Field 11 creates or modifies a line entry in both the Current Element Area 14 and the Full Note Area 15. Tabbing past the Chart Note Entry Field 11 may also create a line entry Header in the Full Note Area 15 if the entered Finding is the first line entry for the current Element. The Current Element Area 14 and the Full Note Area 15 may contain multiple line entries. Each line may include the System or Group, the Parameter, and one or more Findings describing the Parameter. For example, a user clinical finding entry of wheezing in Chart Note Entry Field 11, after tabbing past the field, is entered by the web browser/mobile device as a line in both the Current Element Area 14 and the Full Note Area 15 as Chest (System) Auscultation (Parameter): mild wheezing (Finding). A line entry Element Header “Exam” is also entered in the Full Note Area 15, if wheezing is the first line entered as an Exam line. An additional auscultatory Finding Chart Note Entry Field 11 entry such as ronchi, is appended to the line note entry in both the Current Element Area 14 and the Full Note Area 15: Chest Auscultation: mild wheezing, mild ronchi. Alternatively, a line may contain only a Parameter, when the Parameter requires no Findings.

Along with web browser/mobile device screen layout, the server initially sends JavaScript code to the web browser or mobile device. The JavaScript code includes a reference system of default clinical data and user-customized default clinical data which enables the programmatic formulation of four interactive hierarchal lists consisting of Elements, System/Groups, Parameters and Findings. Each item in the Element list has its own System/Group hierarchal child list, each item in the System/Group hierarchal list has its own Parameter hierarchal child list and each item in the Parameter hierarchal list has its own Finding list hierarchal child list.

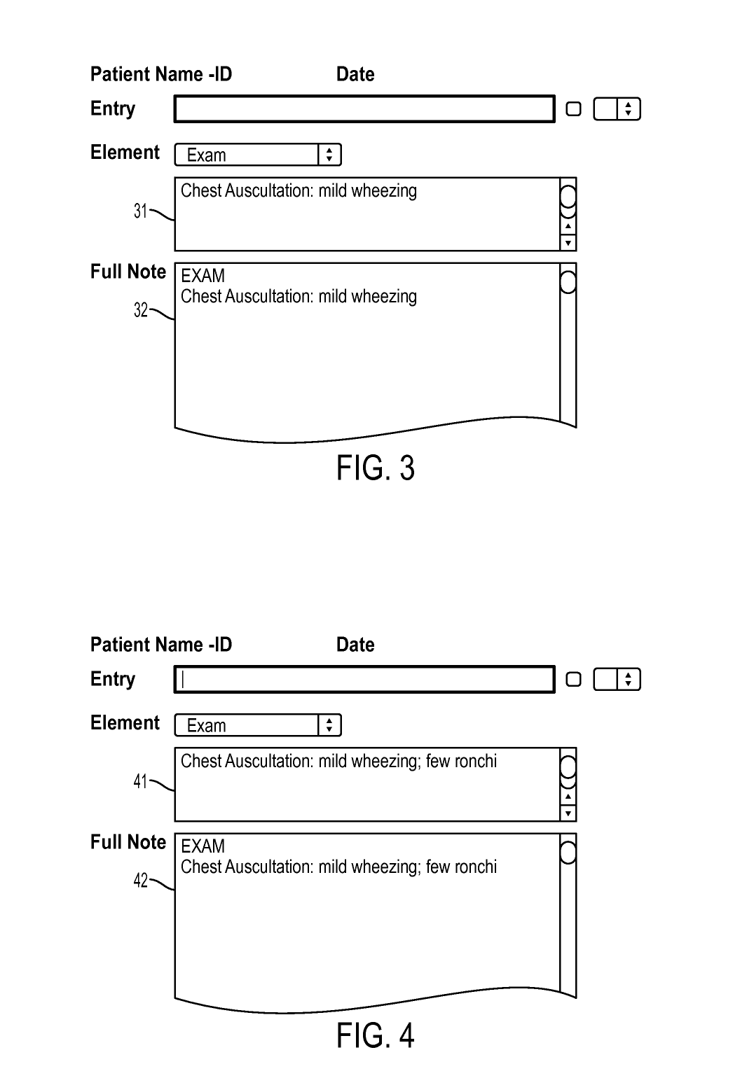

User input of two or more characters in the Chart Note Entry Field 11 and user tabbing past the Field 11 enables the web browser/mobile device programmatic background search of the interactive hierarchal lists. When there is a single match in a Finding hierarchal list, a clinically formatted entry by the web browser/mobile device is programmatically made in the Current Element Area 14 and the Full Note Area 15, consisting of the Finding along with its parent Parameter and (variably) of the Parameter's parent System/Group. Under the Exam Element 22, a programmatic search of user text input “whe” in the Chart Note Entry Field 21 and user tabbing past the field may yield a search result of a single Finding wheezing which is programmatically entered by the web browser/mobile device as Chest Auscultation: mild wheezing in the Current Element Area 31 and the Full Note Area 32. (See FIGS. 2 and 3.)

Some Findings, such as wheezing, may have default severity modifiers which may be quantified as one or more pluses (+) or by descriptive terms denoting increased severity (e.g. mild, moderate, severe/few, moderate, many). The default entry display of a Finding requiring a severity modifier is “+” or with the least severe descriptive phrase. User input of the Finding with one or more “+” plus signs in the Chart Note Entry Field 11 enters the Finding with the commensurate severity in the Current Element Area 14 and the Full Note Area 15. For example, user input of “whe 3+” in the Chart Note Entry Field and user tabbing past the field may yield a search result of the single Finding of wheezing and is entered with a modifier of “severe” as Chest Auscultation: severe wheezing in the in the Current Element Area 14 and the Full Note Area 15. Alternatively, Findings may have no default severity modifiers.

User input of two or more characters in the Chart Note Entry Field 11 and user tabbing past the field enables the web browser/mobile device programmatic background search of the interactive hierarchal lists. When there is a single match in a Finding hierarchal list, and its parent Parameter and the Parameter's parent System/Group have already been entered with another Finding in the Current Element Area 14 and the Full Note Area 15, the new Finding is concatenated onto the same line 41 in the Current Element Area 14 and onto the same line 42 of the Full Note Area 15 as the existing parent Parameter and the Parameter's parent System/Group. For example, “ronc” may yield a search result of a single Finding ronchi, with Auscultation and Chest as its parent Parameter and the Parameter's parent System/Group. If Chest Auscultation: mild wheezing has previously been entered in the Current Element Area 14 and the Full Note Area 15, few ronchi is concatenated onto both the Current Element Area line 41 and the Full Note Area line 42 which share the same Parent and System/Group: Chest Auscultation: mild wheezing; few ronchi.

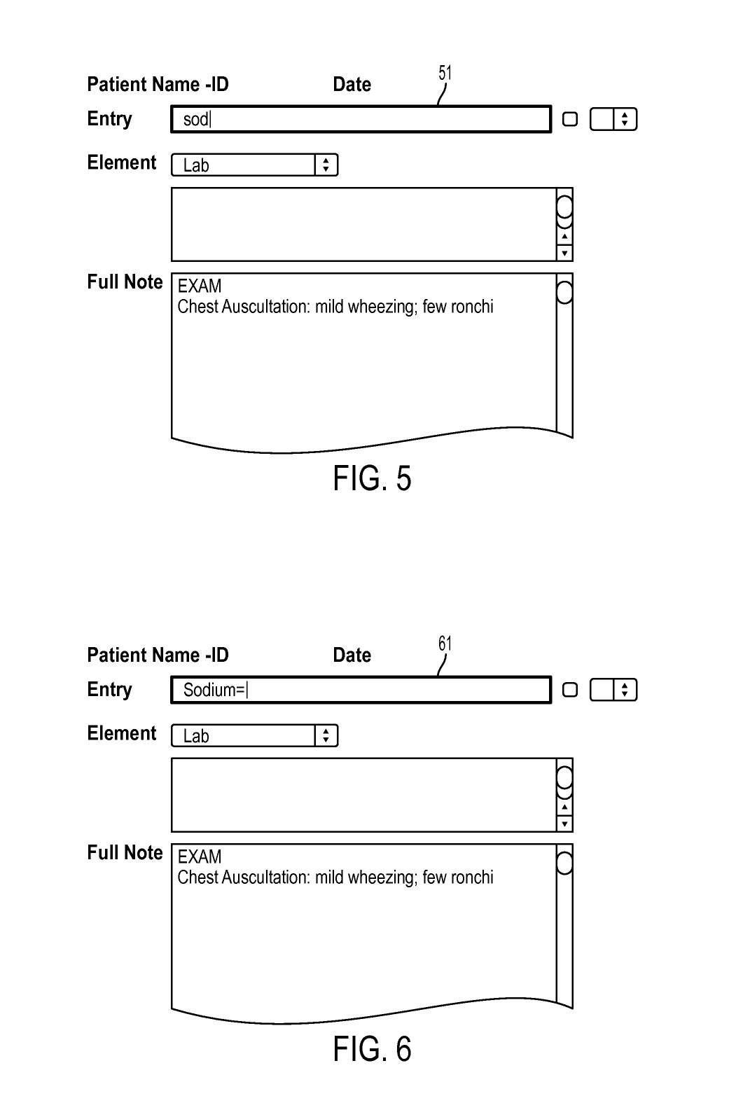

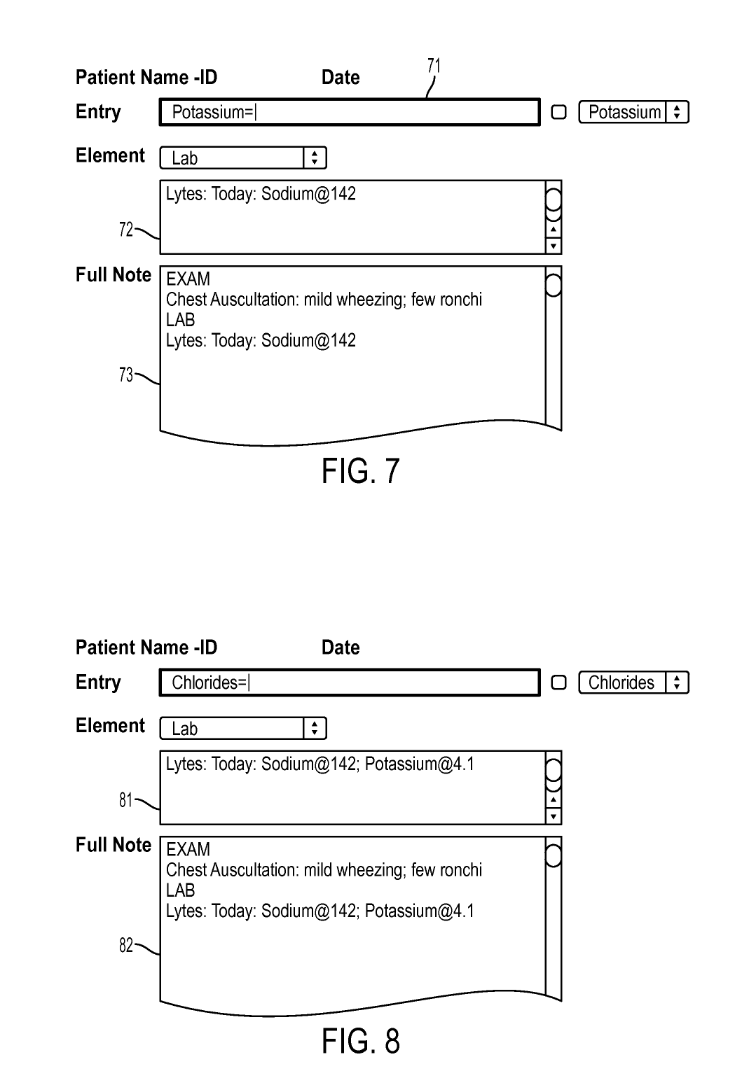

User input of two or more characters in the Chart Note Entry Field 11 and user tabbing past the field enables the web browser/mobile device programmatic background search of the interactive hierarchal lists. When there is a single match in a Finding hierarchal list and the Finding requires a numerical value such as a laboratory test result, the Chart Note Entry Field 11 is refreshed and displays the Finding with an equal sign (=). The cursor is programmatically returned to the Chart Note Entry Field 11 after the equal sign (=). An entry in the Current Element Area 14 and the Full Note Area 15 is not yet been made. User input of a numerical value is concatenated in the Chart Note Entry Field 11 after the equal sign (=), and if the numerical value is within numeric range of the Finding's possible values, tabbing past the field causes the web browser/mobile device to programmatically enter the Finding with its numerical value in the Current Element Area 14 and the Full Note Area 15. For example, as illustrated in FIGS. 5 and 6, user input of “sod” 51 under the Lab Element in the Chart Note Entry Field 11 and tabbing past the field refreshes the Chart Note Entry Field 11 to display “Sodium=” 61, with the cursor returned to the Chart Note Entry Field 11 after the equal (=) sign. As shown in FIG. 7, user input of a numerical value such as “142” after the equal (=) sign into the Chart Note Entry Field 11 and tabbing past the field programmatically enters (by the web browser/mobile device) Lytes: Sodium@142 in the Current Element Area 72 and the Full Note Area 73. A default date e.g. “Today”, may also be entered in the in the Current Element Area 14 and the Full Note Area 15 with a Parameter, for some chart Elements. The date may be changed by the user.

Alternatively, user input of two or more letters along with simultaneous entry of a numerical value into the Chart Note Entry Field 11 and user tabbing past the field programmatically immediately enters (by the web browser/mobile device) the Finding with its value into the Current Element Area 14 and the Full Note Area 15. For example, user input of “sod 142” into the Chart Note Entry Field 11 and user tabbing past the field programmatically enters into the Current Element Area 14 and the Full Note Area 15 Lytes: Today: Sodium@142.

As shown in FIG. 8, Findings requiring a numerical value and sharing the same Parent and System/Group may also be concatenated on the Current Element Area line 81 and the Full Note Area line 82: Lytes: Today: Sodium@142; Potassium@4.1.

Some Parameters may be typically entered with more than one Finding. For example, the Parameter Vital Signs is typically entered with numerical values for blood pressure, pulse, respiratory rate, and temperature. The Parameter Electrolytes is typically entered with numerical values for sodium, potassium, chlorides and bicarbonate. For such Parameters, user entry of a numerical value for one of its Findings in the Chart Note Entry Field 71 and tabbing past the field, in addition to programmatic display as a line in the Current Element Area and as a line in the Full Note Area also programmatically refreshes the Chart Note Entry Field 71 with the Parameter's next Finding concatenated with an equal (=) sign and with the cursor return to the Chart Note Entry Field 71.

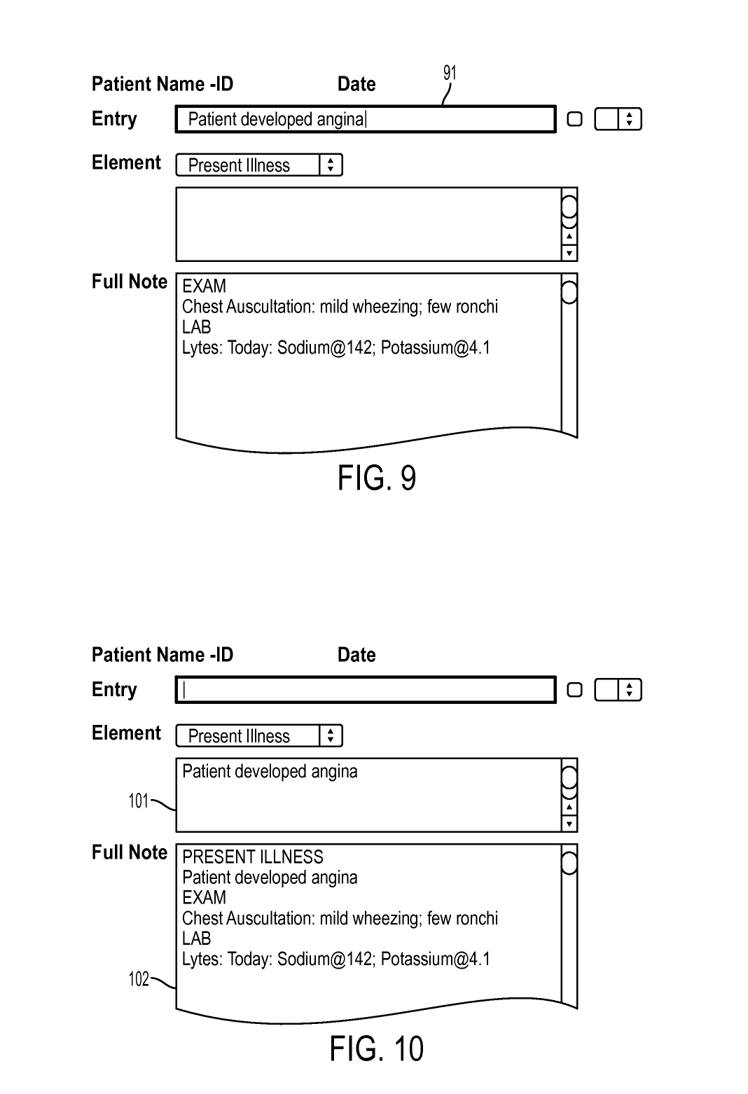

User input of two or more characters in the Chart Note Entry Field 91 and user tabbing past the field enables the web browser/mobile device programmatic background search of the interactive hierarchal lists. If there is no match and more than the programmatically set amount of characters (e.g. 9) has been input by the user in the Chart Note Entry Field 91, tabbing past the field programmatically enters the text as a custom line entry into the Current Element Area and the Full Note Area. For example, as depicted in FIGS. 9 and 10, user input of “Patient developed angina” 91 in the Chart Note Entry Field yields no programmatic search match and user tabbing past the field programmatically enters (by the web browser/mobile device) this text as a line in the Current Element Area 101 and as a line in the Full Note Area 102. The programmatically set amount of characters required for immediate entry into the Current Element Area 101 and the Full Note Area 102 may vary by Element.

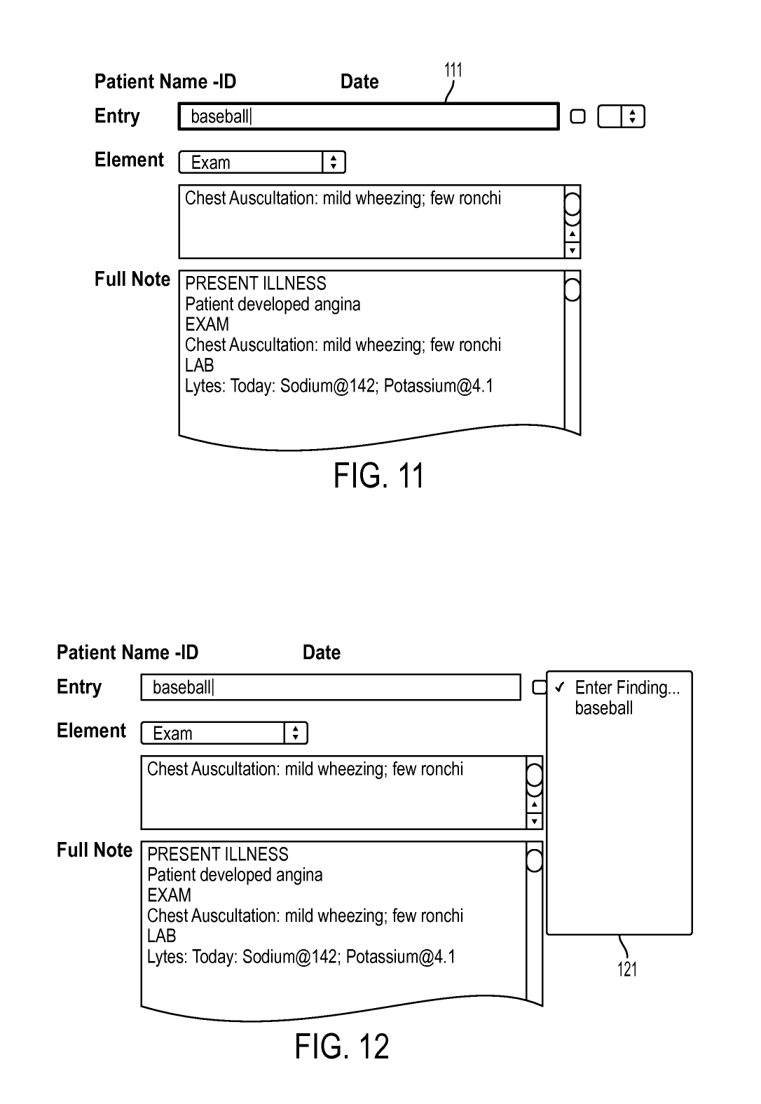

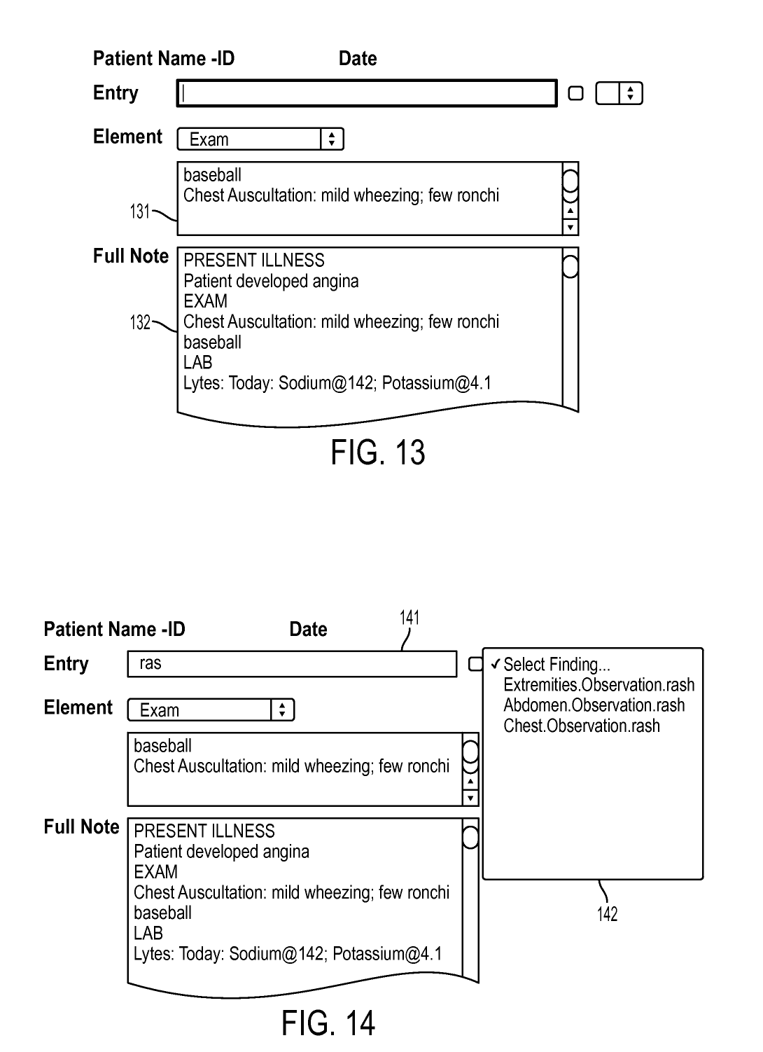

Alternatively, if the input in the Chart Note Entry Field is equal to, or fewer characters than, the programmatically set amount of characters (e.g. 9), tabbing past field causes the programmatic background search to find no search matches, the text is displayed in the View Items Pop-Up Button List 12, rather than being immediately entered in the Current Element Area 14 and the Full Note Area 15. User may then select this item in the View Items Pop-Up Button List 12 for entry of this item as a line in the Current Element Area 14 and as a line in the Full Note Area 15. As shown in FIGS. 11-12, user input of “baseball” in the Chart Note Entry Field 111 yields no programmatic search match and user tabbing past the field programmatically enters the text into the View Items Pop-Up Button List 121. User selecting “baseball” in the View Items Pop-Up Button List 121 enters this item as a line in the Current Element Area 131 and as a line in the Full Note Area 132. (See FIG. 13).

User input of two or more characters in the Chart Note Entry Field and user tabbing past the field enables the programmatic background search of the interactive hierarchal lists. As shown in FIG. 14, when there is more than one the search result, the search results are displayed in the adjacent View Items Pop-Up Button List 142. When the multiple search results are Findings from different Parent hierarchal lists, each item in the View Items Pop-Up Button List 142 displays each Finding along with its parent Parameter and the parent Parameter's parent System/Group. User selection of an item in this View Items Pop-Up Button List 142, enters the Finding as a line in the Current Element Area and as a line in the Full Note Area. For example, user input of “ras” 141 in the Chart Note Entry Field and user tabbing past the field, yields multiple Findings search results, each search result Finding having a different parent Parameter with a different System/Group. These Findings are displayed in the View Items Pop-Up Button List 142:
Extremities.Observation,rash
Abdomen.Observation,rash
Chest.Observation,rash

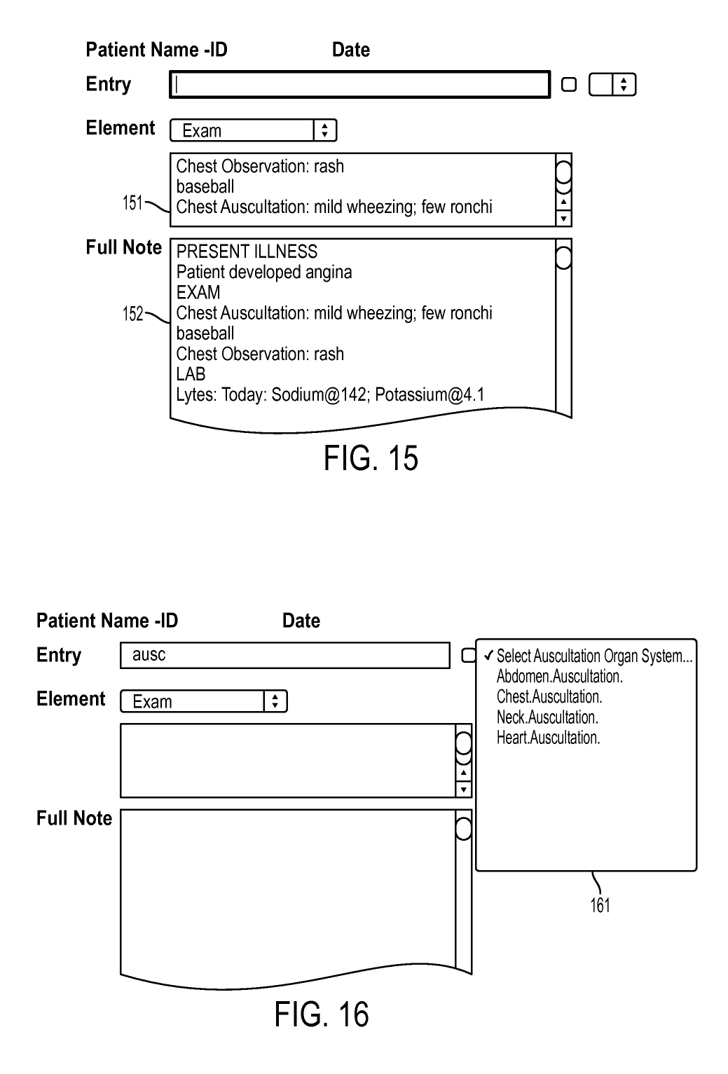

User selection of one displayed Finding item in the View Items Pop-Up Button List, enters this Finding along with its parent Parameter and (variably) parent Parameter's parent System/Group as a line in the Current Element Area and as a line in the Full Note Area. For example, as illustrated in FIG. 15, user selecting Chest.Observation.rash in the View Items Pop-Up Button List enters this Finding in the Current Element Area 151 and the Full Note Area 152 as Chest Observation: rash. When the parent Parameter and the parent Parameter's parent System/Group already exist with another Finding as a line in the Current Element Area 151 and as a line in the Full Note Area 152, the selected Finding is concatenated on the same Current Element Area line and the same Full Note Area line as the existing parent Parameter and the parent Parameter's parent System/Group. For example, if Chest.Observation: paradoxical motion has been previously entered in the Current Element Area 151 and the Full Note Area 152, user selecting Chest.Observation,rash in the View Items Pop-Up Button List will concatenate “rash” to the Current Element Area line and the Full Note Area line: Chest.Observation: paradoxical motion; rash.

User input of two or more characters in the Chart Note Entry Field and user tabbing past the field enables the web browser/mobile device programmatic background search of the interactive hierarchal lists. When there is more than one search result, the search results are displayed in the adjacent View Items Pop-Up Button List. As shown in FIG. 16, when the multiple search results are Parameters, each item in the View Items Pop-Up Button List 161 displays one Parameter as well as its parent System/Group. For example, user input of “ausc” in the Chart Note Entry Field and user tabbing past the field, yields multiple Parameter hierarchal list search results which are displayed in the View Items Pop-Up Button List:
Abdomen.Auscultation
Chest.Auscultation
Neck.Auscultation
Heart.Auscultation

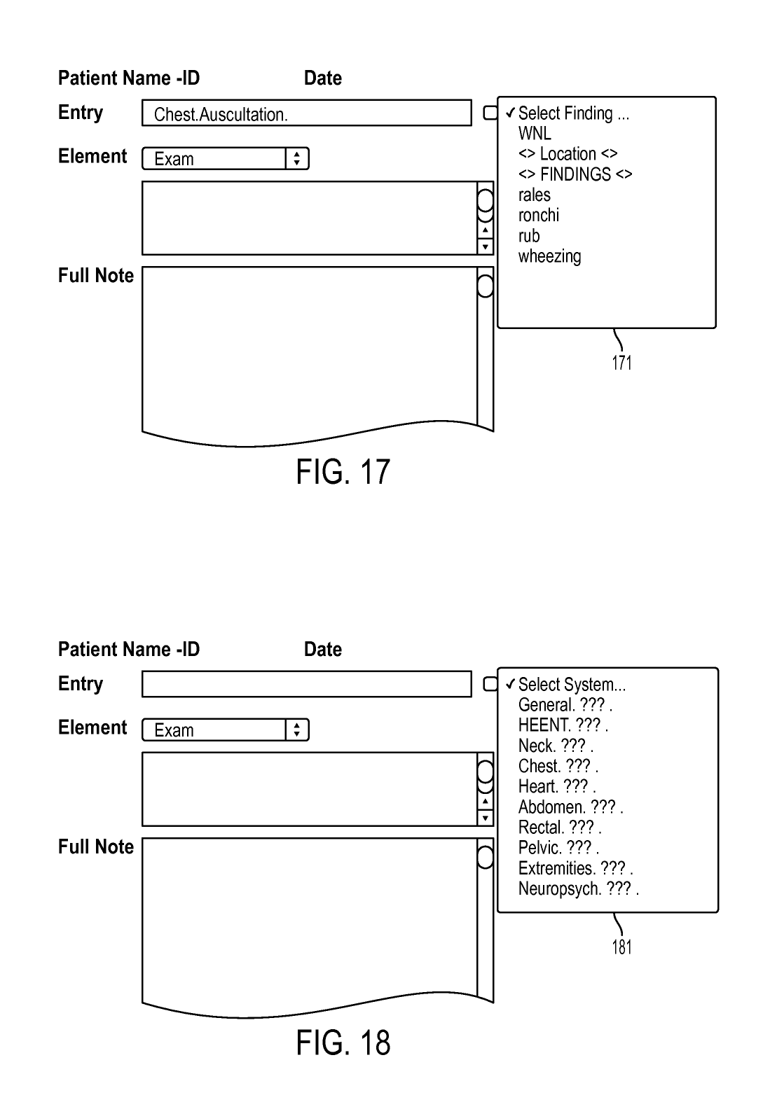

As shown in FIG. 17, user selection of one displayed Parameter item in the View Items Pop-Up Button List 171, refreshes the View Items Pop-Up Button List to display the Parameter's child Findings. For example, user selection of Chest.Auscultation. refreshes the View Items Pop-Up Button List 171 to display the Findings:
rales
ronchi
rub
wheezing

When the programmatic background search result is a single Parameter, the View Items Pop-Up Button List 171 displays the Parameter's child Findings without requiring user selection of the Parameter.

View Items Pop-Up Button List's 171 items may also include Finding headings which are bracketed by the “< >” sign. View Items Pop-Up Button List's 171 Headings are displayed when the Findings hierarchal list contains different kinds of Findings. Clicking a Heading refreshes the View Items Pop-Up Button List 171 to display those Findings grouped under the selected Heading.

User selection of one displayed Finding item in the View Items Pop-Up Button List 171 enters this Finding in a line in the Current Element Area and in a line in the Full Note Area. For example, selecting wheezing in the View Items Pop-Up Button List 171, enters wheezing in the Current Element Area Full Note Area: Chest Auscultation: mild wheezing. Alternatively, tabbing past the View Items Pop-Up Button List 171 may enter only the Parameter in a line in the Current Element Area and in a line in the Full Note Area. For example, the Parameter “Vomiting” may be entered without any of its child Findings (e.g. bilious, bloody, projectile etc.) when entered under Chief Complaint or Present Illness Elements.

User input of two or more characters in the Chart Note Entry Field and user tabbing past the field enables the web browser/mobile device programmatic background search of the interactive hierarchal lists. When there are one or more matches in the System/Group hierarchal list, the search results are displayed in the View Items Pop-Up Button List 12, each item in the View Items Pop-Up Button List 12 displaying the System/Group along with its child Parameters. User input of “ches” in the Chart Note Entry Field and user tabbing past the field, yields one System/Group search result which is displayed with its child Parameters in the View Items Pop-Up Button List 12:
Chest.Observation.
Chest.Palpation.
Chest.Auscultation.
Chest.Percussion.

User selection of one displayed System/Group item refreshes the View Items Pop-Up Button List 12 to display its child Parameter's Findings hierarchal list. For example, user selecting Chest.Auscultation in the View Items Pop-Up Button List 12 refreshes the View Items Pop-Up Button List 12 to display the Findings:
rales
ronchi
rub
wheezing

User input of special characters in the Chart Note Entry Field and user tabbing past the field displays the System/Groups in the View Items Pop-Up Button List. As shown in FIG. 18, Each System/Group item in the View Items Pop-Up Button List 181 is appended with “???”. User input of a special character (e.g. “?” or “/”) in the Chart Note Entry Field and user tabbing past the field, yields the System/Group hierarchal list which is displayed in the View Items Pop-Up Button List 181:
General.???.
HEENT.???.
Neck.???.
Chest.???.
Abdomen.???.

and so on. User selection of a System/Group item in the View Items Pop-Up Button List 181 allows navigation up the child Parameter hierarchal lists and up the child Findings hierarchal lists in the View Items Pop-Up Button List 181 to ultimately populate the View Items Pop-Up Button List 181 with the Findings hierarchal list. The user can also navigate down the hierarchal lists by entering a special character in the Chart Note Entry Field.

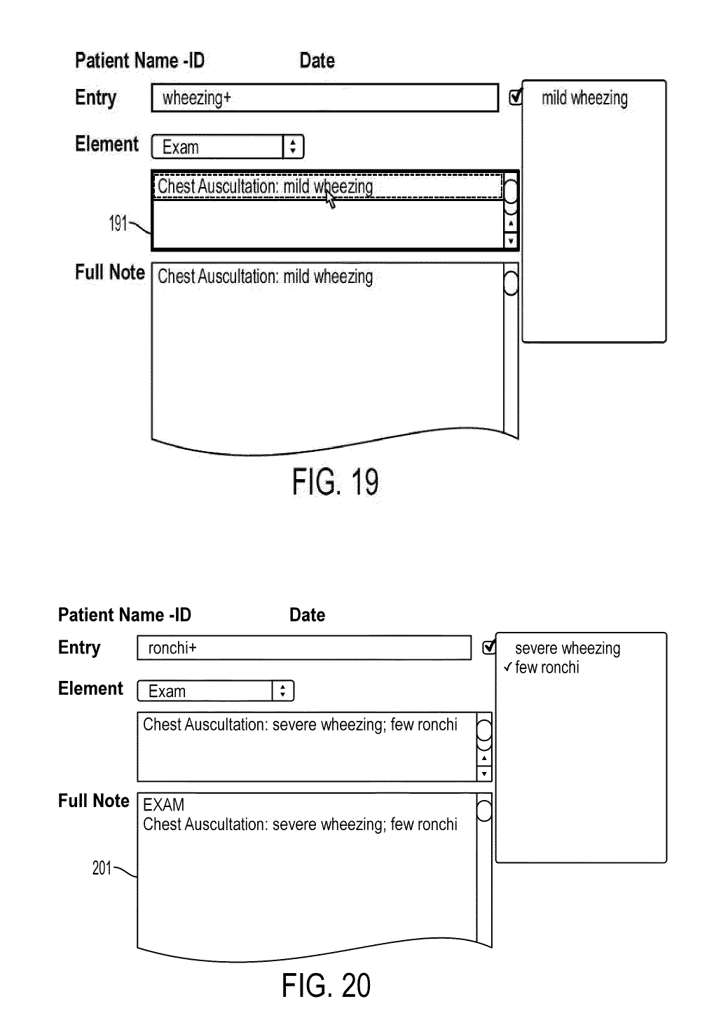

The Current Element Area and the Full Note Area may display one or more lines of at least one entered clinical Finding, along with a Parameter and (variably) a System/Group. Alternatively, a line may contain only a Parameter, when the Parameter requires no Findings. As shown in FIG. 19, when a Current Element Area line 191 displays a single Finding, user clicking on a Current Element Area line 191 displays the Finding in the Chart Note Entry Field for possible modification or possible deletion, as well as in the View Items Pop-Up Button List. The Findings Review Checkbox may be checked to denote that the View Items Pop-Up Button List is displaying at least one previously entered Finding. When a Current Element Area line displays more than one Finding, user clicking the Current Element Area line displays the first Finding in the Chart Note Entry Field and populates the View Items Pop-Up Button List with the clicked line's multiple findings. As shown in FIG. 20, user selection of any one of the Findings in the View Items Pop-Up Button List displays the selected Finding in the Chart Note Entry Field for possible modification or possible deletion. Modifications may include severity, numerical value, location, date as well as other modifiers. Tabbing past the Chart Note Entry Field modifies the Finding in it's line in the Current Element Area and in it's line in the Full Note Area 201. The selected item in the View Items Pop-Up Button List, also displayed in the Chart Note Entry Field, can be deleted from the clinical chart note by clicking on the checked adjacent check box to uncheck the check box. If the displayed Finding is the sole Finding in its Current Element Area line and in its Full Note Area line, the entire line (including the Parameter and variably the System/Group) is deleted in the Current Element Area and in the Full Note Area. If the displayed Finding has additional Findings in its Current Element Area line and in its Full Note Area line, only the Finding is removed from its line in the Current Element Area and the Full Note Area. If the deleted line is the sole line in the Full Note Area line under its Header line, the Header line is also deleted.

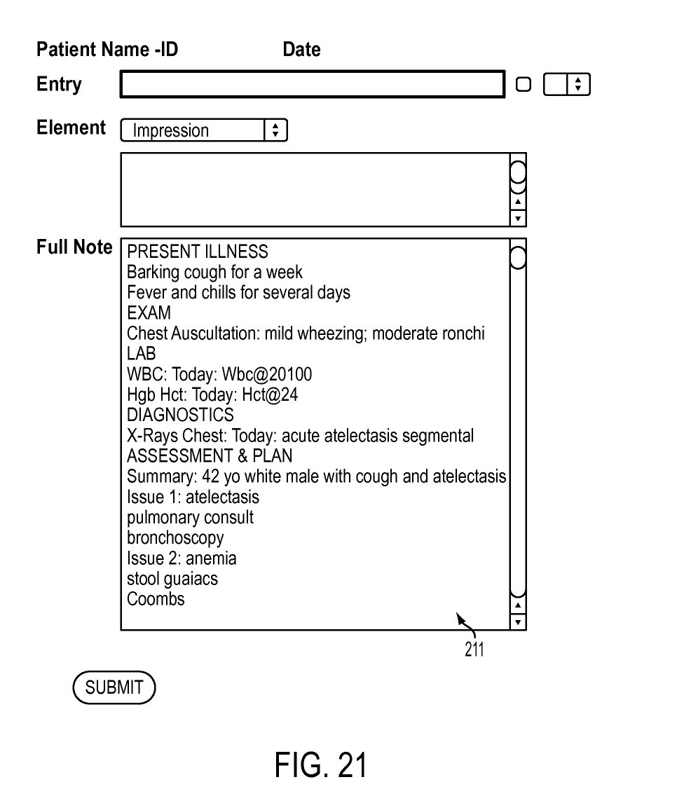

As shown in FIG. 21, the Full Note Area 211 displays the ECCN with all line entries, each line displaying at least a clinical Finding, along with a Parameter and (variably) a System/Group for all chart Elements, grouped by Element. Alternatively, a line may contain only a Parameter, when the Parameter requires no Findings. An Element Header line precedes the line entries of each group of line entries for the same Element. The Past History Element may include Sub-Elements which include the Sub-Elements: Allergies, Medications, Illnesses, Hospitalizations, Family History, Social History and Review of Systems. When an Element also has Sub-Elements, a Sub-Element Header may also be displayed for each group of lines the Sub-Element in the Full Note Area 211. The Assessment and Plan Element may include Sub-elements: Summary, Issues (multiple) and Plans (multiple, each Issue having one or more plans).

User clicking on a Full Note Area's 211 Element Header line causes the Current Element Area to display all the line entries belonging to the Element, as well as changing the selection of the Chart Element Pop-Up Button List to display the same Element as the clicked Element Header line. User clicking on a Full Note Area's 211 Sub-Element Header line may cause the Current Element Area to display only the line entries belonging to the Sub-Element, as well as changing the selection of the Chart Element Pop-Up Button List to display the same Sub-Element as the clicked Sub-Element Header line. User clicking on a Full Note Area 211 line displaying one or more Findings performs the same actions as clicking on a line in the Current Element Area.

User input of one or two characters in the Chart Note Entry Field may select the Current Element Area. For example, “e” selects the Exam Element, “1” selects the Lab Element and “d” selects the Diagnostics Element. Alternatively, a chart Element may be selected in the Chart Element Pop-Up Button List 13. When one of the Elements having Sub-Elements is the current Element, user input of one or two characters in the Chart Note Entry Field may also select a Sub-Element in the Chart Element Pop-Up Button. Alternatively, a Sub-Element may be selected in the Chart Element Pop-Up Button List.

The background interactive hierarchal System/Groups, Parameter and Findings lists are created on the web browser from default values stored on the server and communicated to the web browser/mobile device along with screen layout. These interactive hierarchal lists can also be customized by the user input of custom user terms in the Chart Note Entry Field on the web browser/mobile device. These modified hierarchal list terms are returned to the server upon submission of the completed clinical chart note and stored for subsequent retrieval by the user. The web browser/mobile device subsequently includes these user customized hierarchal list terms in its background search of hierarchal lists for subsequent user entries in the Chart Note Entry Field in subsequent clinical chart notes.

A custom System/Group is created by keystroking a new System/Group term in the Chart Note Entry Field with a specialized character and tabbing past the field. Alternatively, a custom System/Group is created by keystroking a new System/Group term followed by a “.” (period) keystroke and keystroking a new Parameter term followed by a “.” (period) keystroke and tabbing past the field.

A custom Parameter for a System/Group is created by first selecting its System/Group from the View Items Pop-Up Button list for display in the Chart Note Entry Field or by keystroking its System/Group term in the Chart Note Entry Field followed by a “.” (period) keystroke into the Chart Note Entry Field. A custom Parameter term is then keystroked and concatenated into the Chart Note Entry Field and then tabbing past the field.

A custom Finding for a Parameter is created by first selecting its System/Group and Parameter line from the View Items Pop-Up Button list for display in the Chart Note Entry Field or keystroking its System/Group term followed by a “.” (period) keystroke followed by its Parameter term and followed by a “.” (period) keystroke into the Chart Note Entry Field. A custom Finding term is then keystroked and concatenated into the Chart Note Entry Field and then tabbing past the field.

A custom Finding requiring a numerical value is created by keystroking an equal sign (=) after the last “.” (period) in the Chart Note Entry Field prior to tabbing. A custom Finding requiring a default severity is created by keystroking a plus sign (+) after the last “.” (period) in the Chart Note Entry Field prior to tabbing. A custom Finding requiring a descriptive severity other than “+”'s, is created by keystroking a term description of each level of severity after the “+” character, each level of severity separated by a “;” sign prior to tabbing.

A custom System/Group with a custom Parameter and a custom Finding are all simultaneously created by keystroking the new System/Group term, the new Parameter and the new Finding, each separated by a “.” (period) keystroke in the Chart Note Entry Field and tabbing past the field. Tabbing past the field also enters a new non-numerical Finding with its new Parameter and the its System/Group in the Current Element Area and the Full Note Area. Alternatively, tabbing past the field for a new Finding requiring a numerical value refreshes the Chart Note Entry Field to display the new System/Group term, the new Parameter and the new Finding followed by an equal (=) sign, with a return of the cursor to the Chart Note Entry Field following the equal (=) sign.

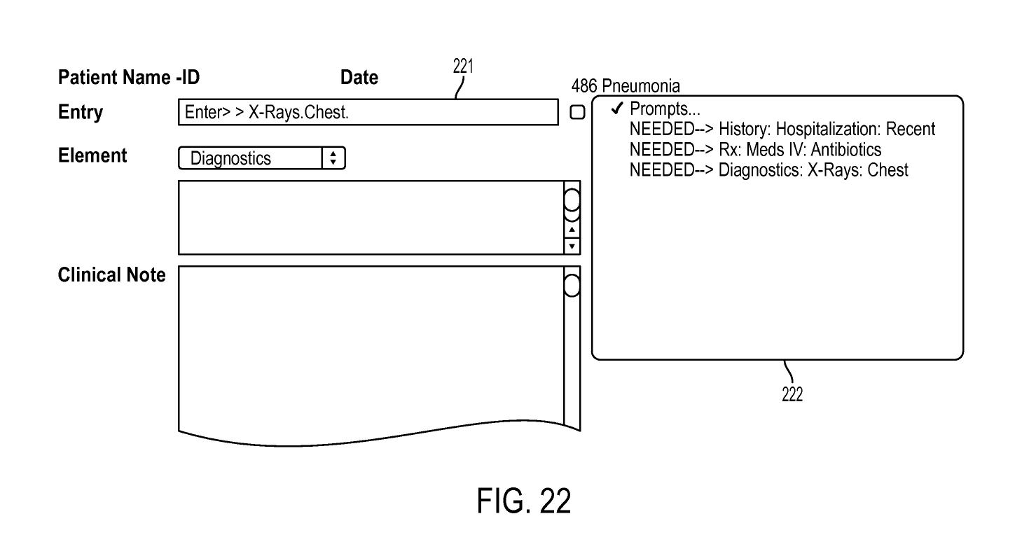

In certain embodiments, the View Items Pop-Up Button List may display Prompts to guide the user for input of clinical findings into the Chart Note Entry Field. When programmatically available, Prompts can be displayed in the View Items Pop-Up Button List by user entering at least one special character in the Chart Note Entry Field or by tabbing past the Chart Note Entry Field and then tabbing past View Items Pop-Up Button List to return the cursor to the Chart Note Entry Field. As shown in FIG. 22, the Chart Note Entry Field 221 then displays the System/Group and Parameter, of a programmatically selected initial Prompt prefixed by a label such as “Enter>>”. The View Items Pop-Up Button List 222 displays one or more Prompts, each Prompt line consisting of at least an Element, a System/Group and a Parameter. The user can select a Prompt in the View Items Pop-Up Button List 222 which then enters the selected System/Group and Parameter in the Chart Note Entry Field, prefixed by a label such as “Enter>>”, as well as repopulating View Items Pop-Up Button List 222 with the Prompt Parameter's child Findings. The user can then enter a clinical Finding by either selecting a Finding in the View Items Pop-Up Button List 222 or keystroking the Finding into the Chart Note Entry Field, which is then concatenated onto the displayed System/Group and Parameter in the Chart Note Entry Field and tabbing past the field. Selecting a Finding in the View Items Pop-Up Button List's 222 Prompt or tabbing past this field causes the web browser/mobile device to programmatically process this Finding, to perform background search of the interactive hierarchal lists and typically manage these search results for display in the Current Element Area and the Full Note Area and to repopulate the View Items Pop-Up Button List 222 with Prompts as a function of the Findings already entered.

In certain embodiments, the View Items Pop-Up Button List's 222 Prompts are based on the reason for the patient clinical encounter. For example, a hospital admission for pneumonia, a patient's doctor/ER visit for an illness such as asthma, a patient's doctor/ER visit for a symptom such as a cough or pain, or a patient's doctor visit to evaluate an abnormal lab or diagnostic finding.

In certain embodiments, the View Items Pop-Up Button List's 222 Prompts can be based on Parameters from previous clinical chart notes created by the user. The clinical chart notes may be subsets of clinical chart notes for the current patient, or for patients with similar diagnoses and/or demographics, as well as for other clinical chart note subsets.

In certain embodiments, the View Items Pop-Up Button List's 222 Prompts, that are based on the reason for the patient clinical encounter, display a prefix for each Prompt that designates the response/clinical relevance status of the Prompt for the reason for the patient-clinician encounter. For example, if the Prompt item has not yet been selected, the prefix is “Needed”. If the clinical Finding entered as a result of the Prompt supports the reason for the patient encounter, the prefix is “Meets”. If the clinical finding does not support the reason for the patient encounter, the prefix is “Not met”. Other prefixes may be used. When a finding has been entered in a line the Current Element Area and in a line the Full Note Area and its System/Group and Parameter has an associated prompt, the line in the Current Element Area and the line in the Full Note Area are each prefixed to designate the clinical relevance of the line to the reason for the patient-clinician encounter. The prefix of “*” may designate that the line supports the reason for the patient encounter. The prefix of “>” may designate that the line does not support the reason for the patient encounter. Other prefixes may also be used.

In certain embodiments, the Chart Note Entry Field's 11 text input is from varying text input sources, other than user keystroke. The Chart Note Entry Field 11 acts as an intake point for varying other input sources to process, organize and display the data from these sources as lines in the Current Element Area 14 and as lines the Full Note Area 15. The Single Text Field text input from varying input sources, in addition to keystroke may be programmatically entered in the Chart Note Entry Field 11 upon user opening of the web browser/mobile device screen, by user text input of specialized characters into the Chart Note Entry Field 11 and tabbing past the field or by user copying and pasting text into the Single Text Field.

In certain embodiments, the Chart Note Entry Field's 11 input is from text downloads, such as laboratory blood test results (e.g. white blood cell counts, electrolytes) and diagnostic test reports (e.g. MRIs, CT scans).

In certain embodiments the Chart Note Entry Field's 11 input is from text from machine (computer/mobile device) assisted analysis (speech recognition) of voice input.

In certain embodiments the Chart Note Entry Field's 11 input is from biometric device readings or machine (computer/mobile device) assisted analysis of biometric device inputs. The biometric devices may be proximate or remote.

In certain embodiments the Chart Note Entry Field's 11 input is from machine (computer/mobile device) assisted analysis of electronic sound inputs from biometric devices, both proximate and remote, via audio file formats (e.g. “.wav”, “.mp3”). One such biometric device is the electronic stethoscope. Machine (computer/mobile device) assisted analysis of the electronic auscultatory findings of body systems (e.g. heart, lungs, abdomen) are transformed into text are programmatically input into the Chart Note Entry Field 11 for entry into the Current Element Area 14 and the Full Note Area 15.

In certain embodiments, the iPhone, mobile device or computer acts as a biometric device which accepts direct audio input of sounds directly from a stethoscope-like bell/diaphragm device or other sound devices.

In certain embodiments biometric devices may include vital sign readers, photographic devices, thermal devices and ultrasound devices and/or transducers. Machine (computer/mobile device) assisted analysis/processing allows the biometric device input into the Chart Note Entry Field 11. Enabling biometric device input allows the patient-clinician clinical encounter to be remote, as well as face-to-face for creating the ECCN.

The ECCN may be printed upon completion of ECCN creation prior to submission to the server, or upon subsequent retrieval of the ECCN from the server. The location of the ECCN printout on the printed page may vary. For example, if the last ECCN printout for the patient occupies the top ⅓ of the printed page, the printout of the current ECCN prints out ⅓ the way down from the top of the page, after and along with the prior ECCN at the top ⅓ of the printed page. The previously printed page with the single ECCN may be discarded and replaced with the current print out of the two ECCNs.

In certain embodiments, separate web browser/mobile device (client) screen also allows user customization of Elements, System/Groups, Parameters and Findings hierarchal lists. Specialists, sub specialists and other health care workers may have unique clinical chart note clinical data terms and may set up or modify the interactive hierarchal lists appropriate for their specialty.

The present invention is described below with reference to block diagrams and operational illustrations of methods and devices to a user interface for an electronic clinical chart note. It is understood that each block of the block diagrams or operational illustrations, and combinations of blocks in the block diagrams or operational illustrations, may be implemented by means of analog or digital hardware and computer program instructions. These computer program instructions may be provided to a processor of a particular machine, physical computing device, general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

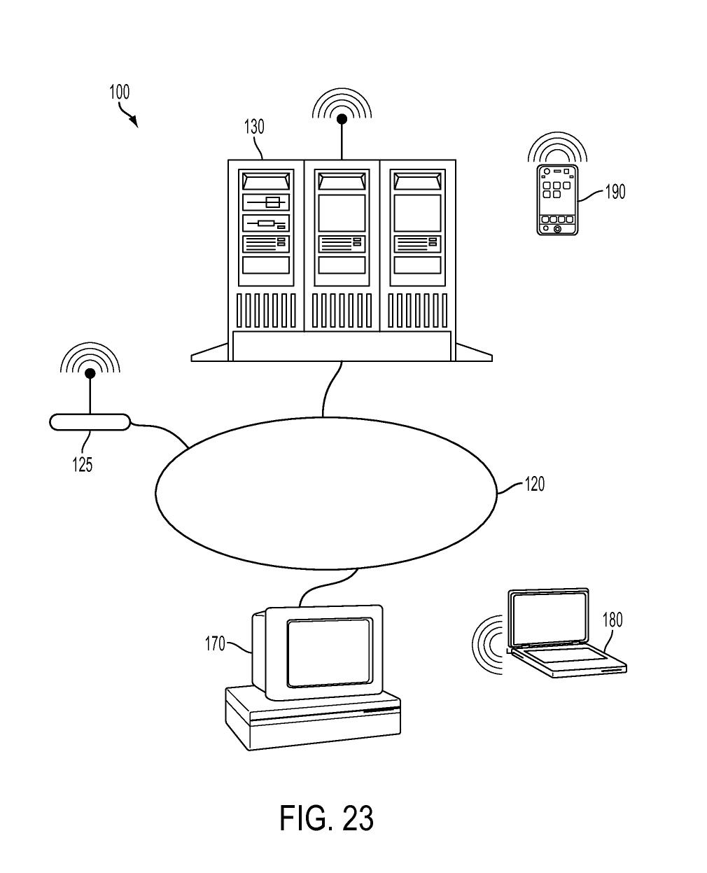

Referring now to FIG. 23, a computer-based system 100 for implementing a user interface for accessing, manipulating, and managing various forms of clinical findings via the Internet in accordance with one embodiment comprises: a data server 130; a computer 170; a laptop computer 180, an iPhone 190, wireless communication device 125; all communicatively connected or coupled via a network 120.

Taken together, the components of computer-based system 100 provide a way for a disparate user base to access one or more components or subsystems of computer-based system 100. While the embodiments set forth herein will be described in detail by using the example of accessing various forms of clinical findings in the context of the Internet, those skilled in the art will recognize that the methods and techniques described herein have broad applicability to other environments and applications where the use of a user interface for accessing, manipulating and managing clinical findings is desirable.

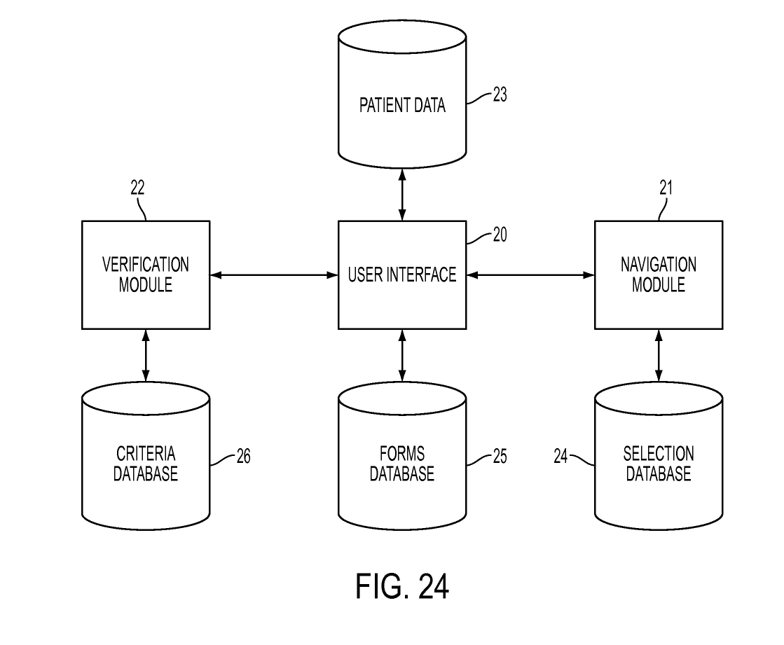

Referring to FIG. 24, the modules are software applications or mechanisms that are configured to interact with users of computer-based system 100 of FIG. 23. The operations of such modules may be executed by a machine, such as a physical computing device. Computer readable medium for managing electronic medical records may comprise of data that causes such a machine to perform the presently disclosed operations. By utilizing such modules, a user can access and interface with various types of clinical findings, including clinical findings stored or referenced in conjunction with a database. In various embodiments, the modules provides a software mechanism for interacting with a web-browser interface for a web-based application delivered to a user's web browser via a web server.

FIG. 24 illustrates the logical arrangement of modules in an electronic medical records system in accordance with the invention. The modules include a user interface 20. The user interface 20 generates the user screens with which the user interacts to submit or review data. The user interface is preferably coupled to a communication link (not shown) that receives user commands and data from a network connection. In one embodiment, the communication link is an Internet connection. In another embodiment, the communication link is a local area network connection. In yet another embodiment, the communication link is a mobile, wireless, remote Internet link. In yet another embodiment, the communication link is a proprietary link.

The user interface 20 preferably facilitates the generation of user screen in accordance with predetermined screen templates and controls. The predetermined templates and controls are advantageously stored in a forms database 25. The user interface 20 is further associated with a patient data storage module 23, which stores patient data that was entered and submitted to the system. The patient data storage module 23 also stores general data relating to health care providers, health care facilities, and managed care organizations. The user interface 20 may store clinical findings regarding a patient-clinician encounter.

In operation, the system provides user screens to the user by employing the user interface 20. The user screens include textual displays and data entry controls that facilitate the submission of data. The screens may be dynamic screens, whereby the selections and data entry interfaces depend on previously entered data. In one embodiment, the dynamic screens are generated when the user interface 20 employs data from other modules in combination with controls and form templates from the forms database 25.

The client side application may comprise a typical web browser application such as Microsoft Internet Explorer, Apple Safari, Netscape Navigator, Mozilla Firefox, etc. Those skilled in the art will recognize that there are many different web browsers that may be deployed to accomplish the objects of the present invention. Additionally, in at least one embodiment, one or more web browser plug-in and/or JavaScript code may be configured for use with web browser application. The client side application may be configured to communicate with a server side application via network, such as the Internet. In the most embodiments, a web browser plug-in and/or code may be configured to implement the functionality of the various mechanisms of a server side application.

Web browser plug-ins are representative of the class of programmatic or software applications that are used to extend or expand the functionality of web browser. Examples of applications that may be deployed as a web browser plug-in includes PDF viewers, Flash viewers, etc. In the most embodiments, web browser plug-in is a content plug-in used to enable web browser to accurately display and/or manage one or more clinical findings.

Code is representative of the class of programmatic or software applications that are used to extend or expand the functionality of web browser. These types of applications may be JavaScript, JAVA applets, Active X components, scripts, etc. In certain embodiments, code will be a special purpose application used to enable web browser to accurately display and/or manage clinical findings. In at least one embodiment, code is incorporated into a server side application.

While the invention has been particularly shown and described with reference to a preferred embodiment thereof, it will be understood by those skilled in the art that various changes in form and details may be made therein without departing from the spirit and scope of the invention.

What is claimed is:

1. A method for managing electronic medical records, comprising the steps of:
receiving a clinical finding of a patient-clinician clinical encounter, wherein the clinical finding is received via a single field;
creating an electronic clinical chart note;
displaying the clinical finding in clinical chart note format, wherein the clinical chart note format emulates a paper clinical chart note format; and
storing the electronic clinical chart note to a server,
wherein the receiving step, creating step, displaying step, and storing step are performed on at least one particular machine, said at least one particular machine comprising at least one physical computing device.

2. The method of claim 1, furthering comprising:
transmitting the electronic clinical chart note to the server, wherein the server is remote.

3. The method of claim 1, furthering comprising:
retrieving the electronic clinical chart note from the server.

4. The method of claim 1, furthering comprising:
cumulating electronic clinical chart notes for a single patient; and
creating an electronic medical record for the single patient based on the electronic clinical chart notes for the single patient.

5. The method of claim 1, wherein the electronic clinical chart note is stored in clinical chart note format.

6. The method of claim 1, wherein the clinical finding of the patient-clinician clinical encounter is received via an user interface.

7. The method of claim 6, wherein the user interface is a web browser.

8. The method of claim 6, wherein the clinical finding of the patient-clinician clinical encounter is entered by a user via an user interface into the single field.

9. The method of claim 8, wherein the single field is configured to receive the clinical finding from a source selected from the group consisting of: a keyboard, a touch screen, a sound source, a data download, a biometric device, or an auscultatory device.

10. The method of claim 9, wherein the source of the input is remote from the user interface.

11. The method of claim 7, wherein the web browser is displayed by a screen on a device selected from the group consisting of a computer or a mobile device.

12. The method of claim 1, furthering comprising:
programmatically generating at least one interactive hierarchal list; and
displaying the programmatically generated at least one interactive hierarchal list via the user interface.

13. The method of claim 12, wherein the programmatically generated at least one interactive hierarchal list is based on data selected from the group consisting of: default clinical data, the received clinical finding of the patient-clinician clinical encounter, or previously stored electronic clinical chart notes.

14. The method of claim 12, wherein the programmatically generated at least one interactive hierarchal list is selected from the group consisting of elements, systems, parameters, or findings.

15. The method of claim 12, furthering comprising:
selecting from the programmatically generated at least one interactive hierarchal list.

16. The method of claim 12, furthering comprising:
programmatically generating a second interactive hierarchal list based on a selection from the programmatically generated at least one interactive hierarchal list, wherein each item listed in the programmatically generated at least one interactive hierarchal list has a hierarchal child list; and
displaying the second interactive hierarchal list via the user interface, wherein the displayed second list is the hierarchal child list corresponding to the selected item from the programmatically generated at least one interactive hierarchal list.

17. The method of claim 12, furthering comprising:
modifying the at least one interactive hierarchal list, wherein the modified hierarchal list is based on a separate clinical finding, wherein the separate clinical finding is a subsequently received finding or a previously stored finding; and
displaying the modified hierarchal list.

18. The method of claim 1, furthering comprising:
prompting for clinical finding information, wherein at least one prompt is based on information selected from the group consisting of: a previously stored electronic clinical chart note, the first letters of the received clinical finding, or a reason for the patient-clinician clinical encounter.

19. The method of claim 1, furthering comprising:
concurrently displaying the clinical finding in clinical chart note format as the clinical finding is received.

20. The method of claim 19, wherein the formatted clinical finding is displayed when a user tabs past the single field.

21. The method of claim 1, wherein the receiving step, creating step, displaying step, and storing step are performed on the same particular machine.

22. The method of claim 1, wherein the receiving step, creating step, displaying step, and storing step are performed on separate particular machines.

23. The method of claim 1, wherein the electronic clinical chart note is based on a plurality of clinical findings concerning the patient-clinician clinical encounter, and wherein the plurality of clinical findings is received via the single field.

24. The method of claim 23, furthering comprising:
concatenating the plurality of clinical findings concerning the patient-clinician clinical encounter;
displaying the concatenated clinical findings.

25. The method of claim 1, wherein the clinical finding is received via a technique selected from the group consisting of: cutting and pasting data, downloading text data, transmitting device readings, or providing a machine assisted analysis.

26. The method of claim 1, wherein the clinical finding has a severity modifier.

27. An electronic medical records system, comprising:
an interface that receives a clinical finding of a patient-clinician clinical encounter, wherein the clinical finding is received via a single field, wherein the interface displays the clinical finding in clinical chart note format, and wherein the clinical chart note format emulates a paper clinical chart note format;
a server that stores an electronic clinical chart note, wherein the electronic clinical chart note is based on the clinical finding; and
a particular machine, wherein the particular machine stores code for the interface and code for the server.

28. The system of claim 27, wherein the code for the interface and the code for the server are stored on a single particular machine.

29. The system of claim 27, wherein the code for the interface and the code for the server are stored on separate particular machines.

30. The system of claim 27, wherein the interface is a web browser.

31. The system of claim 30, wherein the web browser is displayed by a screen on a device selected from the group consisting of a computer or a mobile device.

32. The system of claim 27, wherein the interface is configured to receive the clinical finding from a source selected from the group consisting of: a keyboard, a touch screen, a sound source, a data download, a biometric device, or an auscultatory device.

33. The system of claim 27, wherein the interface programmatically generates interactive hierarchal lists based on the clinical finding of the patient-clinician clinical encounter for the creation of the electronic clinical chart note, wherein the interface displays the programmatically generated interactive hierarchal lists.

34. The system of claim 27, wherein the interface retrieves the electronic clinical chart note from the server.

35. A computer readable medium for managing electronic medical records, comprising data that, when accessed by a machine, cause the machine to perform operations comprising:
receiving a clinical finding of a patient-clinician clinical encounter, wherein the clinical finding is received via a single field;
creating an electronic clinical chart note;
displaying the clinical finding in clinical chart note format, wherein the clinical chart note format emulates a paper clinical chart note format; and
storing the electronic clinical chart note to a server;
wherein the receiving operation, creating operation, displaying operation, and storing operation are executed on at least one particular machine, said at least one particular machine comprising at least one physical computing device.
